(19) United States
(12) Patent Application Publication
(10) Pub. No.: US 2005/0002050 A1
(43) Pub. Date: Jan. 6, 2005

(54) Image processing apparatus

(75) Inventor: Naofumi Yamamoto, Kanagawa-ken (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/609,611

(22) Filed: Jul. 1, 2003

(51) Int. Cl. G06F 9/28; G06F 9/44; G06F 11/30; G06F 3/12; G06F 15/00; G06T 1/60

(52) U.S. Cl. 358/1.13; 358/1.16; 382/305; 718/105; 358/404; 382/304

(57) ABSTRACT

A method and apparatus for processing image data is provided, including a buffer configured to store processed image data for providing to an output device, and a processing unit configured to process image data into the processed image data to be stored in the buffer. The processing unit is configured to operate at a first speed when a remaining capacity in the buffer has less than a predetermined remaining capacity value, and to operate at a second speed when the remaining capacity in the buffer has at least the predetermined remaining capacity value, the second speed being greater than the first speed.

### BACKGROUND OF THE INVENTION

A. Field of the Invention

The invention relates generally to an image processing apparatus, and more particularly, to a method and apparatus for selectively processing image data at one of selective speeds.

B. Background of the Invention

Image processing devices are known. One such device is described in Japanese Reference JP 2001-169106, which is incorporated by reference herein in its entirety. Image data processed by image processing devices varies in complexity from one image job to another. By way of example, white areas in black-and-white (B/W) text documents constitute a small amount of image data, requiring relatively little processing. In contrast, detailed color images are more complex and require substantially more processing than B/W text documents. Similarly, high-quality images (e.g., digital photographs with high resolution) require substantially more processing than low-quality images (e.g., digital photographs with low resolution). Thus, image data varies in complexity from one image job to another, resulting in varying processing requirements from one image job to another.

In conventional image processors, however, application specific integrated circuits (ASICs) are used to process image data. The ASICs process data at a fixed rate. Such ASICs are normally designed for the worst-case scenario, i.e., the “highest” possible image data processing requirement. They operate at a sufficiently high rate to process the most complex image data all the time, even when a high processing rate is not required for all image jobs. Conventional ASICs cannot efficiently perform high quality and low quality image processing for less complex image data, as this would impermissibly lower the image processing rate for the more complex image data.

Thus, a need exists for a method and apparatus for selectively processing image data at at least a first speed and a second speed to allow for low speed-high quality image processing of image data. Further, the processing can be optimized using the processor of an image processing apparatus, as properly programmed.

### SUMMARY OF THE INVENTION

According to one embodiment of the present invention, an image processing apparatus is provided, including a buffer configured to store processed image data for providing to an output device, and a processing unit configured to process image data into the processed image data to be stored in the buffer. The processing unit is configured to operate at a first speed when a remaining capacity in the buffer has less than a predetermined remaining capacity value, and to operate at a second speed when the remaining capacity in the buffer has at least the predetermined remaining capacity value, the second speed being greater than the first speed.

According to another embodiment of the present invention, an image processing apparatus is provided, including a buffer configured to store processed image data for providing to an output device, and a processing unit configured to process image data into the processed image data to be stored in the output buffer. Preferably, the processing unit includes a first processor programmed to process the image data, the first processor configured to perform either a high-speed processing program or a low-speed processing program, a second processor programmed to process the image data, the second processor configured to perform either the high-speed processing program or the low-speed processing program, and a controller configured to process the image data using a selective one or both of the first processor and the second processor, and controlling the selected one or both of the first processor and the second processor to each operate in the high-speed processing program or the low-speed processing program based on a remaining capacity in the output buffer.

According to another embodiment of the present invention, a method of processing image data is provided, including receiving image data to be processed, selecting one of a first processing speed and a second processing speed based on a remaining capacity of a buffer, processing the image data at the selected processing speed, and sending the processed image data to the buffer. Processing is done at the first processing speed when the remaining capacity is less than a predetermined remaining capacity value, the second processing speed being greater than the first processing speed.

Further features, aspects and advantages of the present invention will become apparent from the detailed description of preferred embodiments that follows, when considered together with the accompanying figures of drawing.

### BRIEF DESCRIPTION OF THE DRAWINGS

Advantages and features of the invention will become apparent upon reference to the following detailed description and the accompanying drawings, of which:

FIG. 1 is a block diagram of an image processing apparatus according to a first embodiment of the present invention.

FIG. 2 is a block diagram of an image processing apparatus according to a second embodiment of the present invention.

FIG. 3 is a block diagram of an image processing apparatus according to a third embodiment of the present invention.

FIG. 4 is a timing diagram of an output from a processing unit according to an embodiment of the present invention.

### DETAILED DESCRIPTION OF PREFERRED EMBODIMENTS OF THE INVENTION

Reference will now be made in detail to presently preferred embodiments of the invention. Wherever possible, the same reference numbers will be used throughout the drawings to refer to the same or like parts.

An image processing apparatus 100, such as a multi-function peripheral, according to a first embodiment of the present invention is shown in the block diagram of FIG. 1. The image processing apparatus 100 is configured to receive image data from an input device 110, (e.g., a scanner, a photographing mechanism, a computer, etc.), processes it, and outputs the processed image data to an output device 170 (e.g., a printer, a telephony device, a data storage device, etc.). The image processing apparatus 100 preferably includes a preprocessing device or preprocessor 120, a processing unit or processor 130, one or more accelerators 140, a random access memory (RAM) 150, and an output buffer 160. Other components may also be provided or various components combined in whole or in part, as would be readily apparent to one of ordinary skill in the art after reading this disclosure.

The preprocessing device 120 is configured to perform any preprocessing operation, such as apparatus warm up, image shading, image stabilization, and the like, as understood in the art, and may or may not be required for a particular implementation. Image data preprocessed by preprocessing device 120 is then further processed by processor 130, as described in greater detail below. Further, depending on the particular implementation, the accelerator(s) 140 may be used to augment the performance of processor 130, such as performing routine image processing functions. The processed image data is then buffered in output buffer 160, for buffering a data stream to output device 170.

As noted above, processor 130 is used to process the image data in the image processing apparatus 100 with or without supplementation by preprocessing device 120 and/or accelerator 140. Processor 130 is preferably configured to process the image data at the highest possible quality, which has a corresponding lowest processing speed, as often as possible. The processing time of image data depends on (a) the complexity of the image data and (b) the quality at which that image data is being processed. Processing a large amount of complex image data at the highest possible quality translates to a relatively lower rate of processed image data being buffered into output buffer 160 due to the low processing speed. In this situation, output buffer 160 may output processed image data to the output device 170 faster than its receipt of processed image data from processor 130. Thus, for example, a printer as output device 170 may be obtaining the output information from the output buffer at its fixed rate faster than the output buffer (which may be the printer buffer) is being filled with information based on the processing by the processing unit. This discrepancy may result in output buffer 160 becoming empty even though processing and outputting has not been completed, causing a delay in outputting data from output device 170, such as when printing a document.

Processor 130 according to the present embodiment is configured to operate at a first, low speed while a remaining capacity in the output buffer 160 is less than a predetermined remaining capacity value. This predetermined remaining capacity value may be selected at a level where output buffer 160 is relatively full (i.e., a relatively low remaining capacity). That is, processor 130 will operate at the low speed while output buffer 160 is at least a certain amount full. Processor 130 may operate at a second, high speed when the remaining capacity in output buffer 160 is at least the predetermined remaining capacity value, such as output buffer 160 being relatively empty. The second speed, as indicated, is greater than the first speed. By way of example, processor 130 may change from processing at the first speed to the second speed when output buffer 160 becomes nearly or essentially empty. Preferably, the predetermined remaining capacity value is about 50% capacity of the output buffer 160. Alternatively, the predetermined remaining capacity value may be about 75% capacity or about 90% capacity of the output buffer 160. By way of example, for the 90% capacity of the output buffer, this means that the processor 130 will operate at the first speed as long as the output buffer is at least 10% full. Other values are also plausible, depending in part on the actual first and second speeds selected for any particular processing unit.

FIG. 4 shows an exemplary operation of processor 130, where processor 130 switches its operational speed for processing image data depending on the remaining capacity of output buffer 160. As shown in FIG. 4, processor 130 switches from the presumptive first speed to the second speed at time T₁ when output buffer 160 is almost empty (shown as the lower limit of processing output in FIG. 4). Processor 130 processes the image data at the second speed until time T₂ where output buffer 160 has become relatively full (shown as the upper limit of processing output in FIG. 4), which corresponds to the remaining capacity in the output buffer 160 dropping below the predetermined remaining capacity. At this point, processor 130 switches back to processing the image data at the first speed. The image data is again processed at the first speed until time T₃, where the remaining capacity exceeds the predetermined remaining capacity, and the process repeats itself. In this manner, processor 130 operates at the first speed, corresponding to a high quality/low speed image processing, as often as possible. Processor 130 uses the second speed, corresponding to a low quality/high speed image processing, to more quickly refill the output buffer 160 when it runs low.

An image processing apparatus 100 as set forth above thus selectively processes image data at different speeds, allowing image processing apparatus 100 to perform higher quality image processing than conventional devices which process data at a fixed rate. Processor 130, when operating at the low speed, can be partially freed to perform other activities as may be necessary in the image processing apparatus, thereby increasing its efficiency and use.

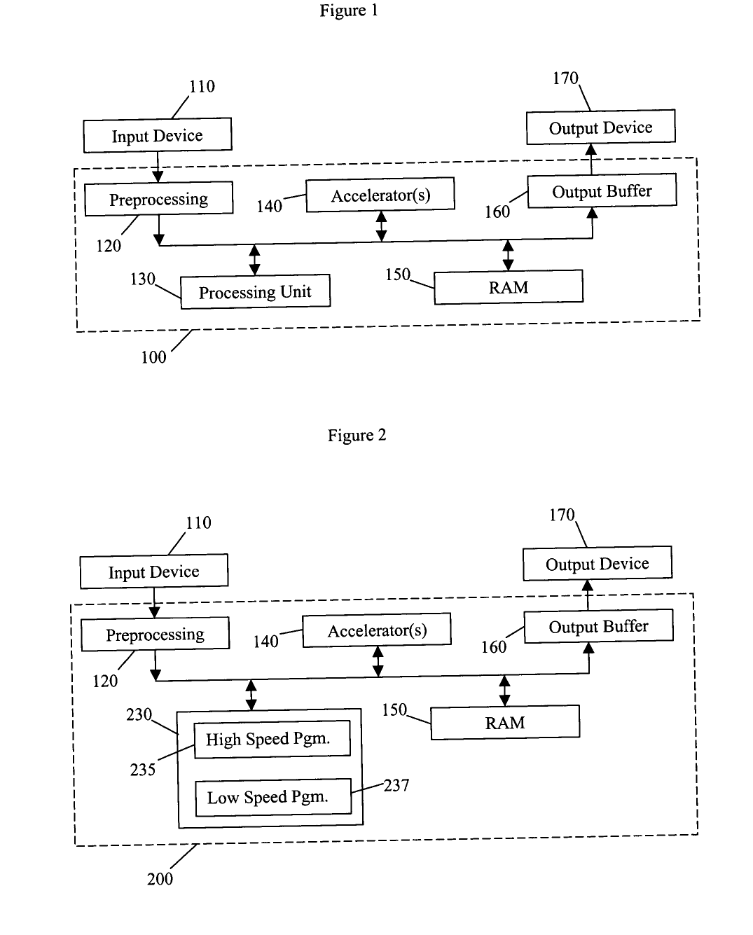

FIG. 2 depicts a second embodiment of the present invention, where an image processing apparatus 200 includes a processing unit or processor 230 that switches between a first speed using a low speed/high quality processing program 237 and a second speed using a high speed/low quality processing program 235. Additional gradations between high speed/low quality program 235 and low speed/high quality processing program 237 (not shown) may also be provided.

In this manner, the processor (such as a digital signal processor (DSP)) may be programmed to perform the two (or more) different processing programs 235, 237. The programs may themselves be stored, for example, in a memory such as RAM 150. Rather, a single processor can be simply controlled and operated so as to perform the varying processing rates/qualities required.

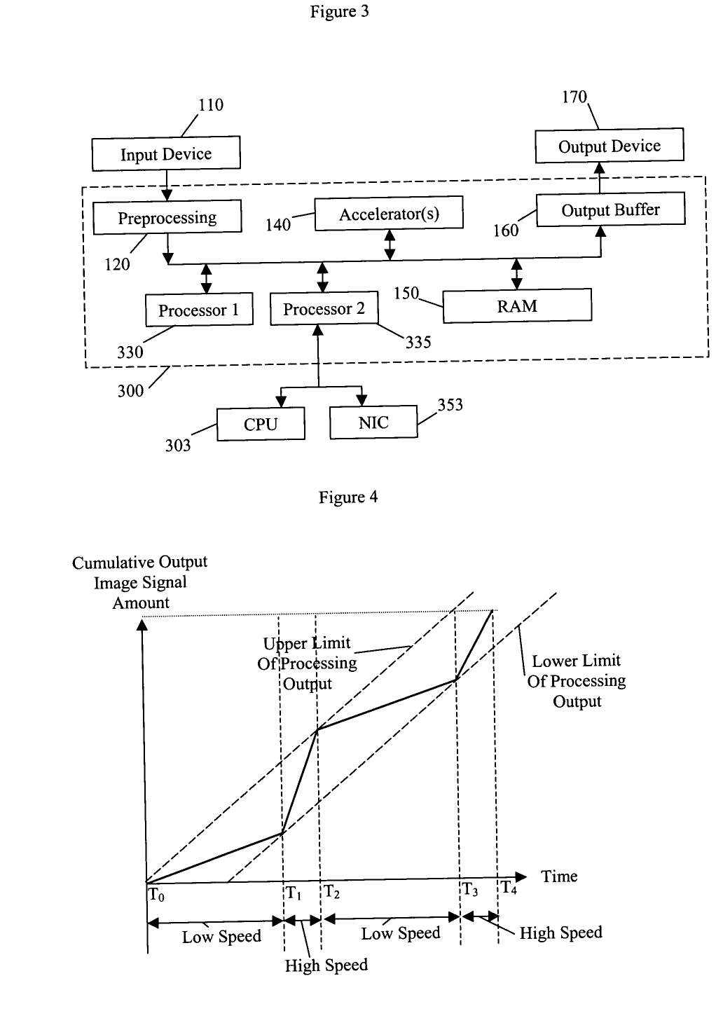

FIG. 3 shows a third embodiment of the present invention, where an image processing apparatus 300 includes a first processor 330 and a second processor 335. The image processing apparatus 300 processes image data using only first processor 330 when operating at the first, low speed, and processes image data using both first processor 330 and second processor 335 when operating at the second, high speed. It should be appreciated that, though two processors 330 and 335 are shown in this embodiment, more than two processors may be used as would be readily apparent to one of ordinary skill in the art after reading this disclosure.

Using this multi-processor technique, image processing apparatus 300 can selectively use image processor 335 to increase the image processing rate, which may also be used for performing additional tasks such as controlling a network interface card (NIC) 353 or functions requested by a central processor unit (CPU) 303. In this manner, image processing apparatus 300 may take advantage of a plurality of processors that are typically used to perform other tasks similar to multi-threading without reducing the quality of the image processing. Thus, the data rate can be increased while using the same high-quality image processing program 237.

As yet another alternative embodiment of the present invention, the multi-processor image processing apparatus 300 shown in FIG. 3 may be used in conjunction with the multi-program image processing apparatus 200 shown in FIG. 2. By way of example, each of the image processors 330 and 335 may switch between a high speed processing program 235 and a low speed processing program 237. Thus, multiple modes are possible, including: (1) one processor 330 running low speed processing program 237; (2) two processors 330, 335 each running low speed processing program 237; (3) one processor 330 running high speed processing program 235; and (4) two processors 330, 335 each running high speed processing program 235. The image processing apparatus 300 may then select the appropriate processing mode (1) to (4) based on a detected level within output buffer 160, thereby tailoring the processing speed as needed in a particular situation. As such, the present embodiment can be configured to provide a range of image processing speeds and qualities, while maintaining a sufficient amount of data within output buffer 160 for outputting to output device 170.

With the embodiments described above, when the image processing unit is working with a fixed output rate device, such as a printer, it can adjust its processing speed based on the image data that is being processed for printing by the printer, so that a fixed rate of output from the printer can be obtained rather than unwanted breaks in the printing. Further, the image processing can keep up with the fixed rate output of the printer by switching to a higher speed when the output buffer for the printer is nearly empty.

While various exemplary embodiments have been set forth above, many modifications and variations may be made to the techniques and structures described and illustrated herein without departing from the spirit and scope of the invention. By way of example, various method steps described may be combined in whole or in part, may be rearranged in order of performance, and/or may be omitted in some applications. Aspects of the embodiments may be combined with one another. Accordingly, it should be understood that the methods and apparatus described herein are illustrative only and are not limiting upon the scope of the invention.

1. An image processing apparatus, comprising:
a buffer configured to store processed image data for providing to an output device; and
a processing unit configured to process image data into said processed image data to be stored in said buffer,
wherein said processing unit is configured to operate at a first speed when a remaining capacity in said buffer has less than a predetermined remaining capacity value, and
wherein said processing unit is configured to operate at a second speed when the remaining capacity in said buffer has at least said predetermined remaining capacity value,
wherein said second speed is greater than said first speed.

2. The image processing apparatus according to claim 1, wherein said processing unit is configured to change from the first speed to the second speed if the buffer is about empty.

3. The image processing apparatus according to claim 1, wherein said processing unit comprises a processor configured to perform a high-speed processing program when operating at said second speed and configured to perform a low-speed processing program when operating at said first speed.

4. The image processing apparatus according to claim 1, wherein said processing unit comprises:
a first processor programmed to process said image data;
a second processor programmed to process said image data; and
a controller configured to process said image data using both said first processor and said second processor when operating at said second speed, and configured to process said image data using only said first processor when operating at said first speed.

5. The image processing apparatus of claim 4, wherein said second processor is configured to be used for another function when not being used by said controller for processing said image data.

6. The image processing apparatus of claim 5, wherein said another function includes at least one of raster image processing and image processing for scanned image data.

7. The image processing apparatus of claim 1, wherein said processing unit is configured to monitor a remaining capacity of the buffer.

8. The image processing apparatus of claim 7, wherein monitoring said remaining capacity of the buffer is performed by a processor programmed to monitor said remaining capacity of the buffer.

9. The image processing apparatus of claim 1, further comprising an accelerator configured to process at least a portion of said image data into said processed image data.

10. The image processing apparatus according to claim 1, wherein said output buffer is first-in-first-out (FIFO) buffer.

11. An image forming device including an image processing apparatus according to claim 1.

12. An image processing apparatus, comprising:
a buffer configured to store processed image data for providing to an output device; and
a processing unit configured to process image data into said processed image data to be stored in said output buffer, wherein said processing unit comprises
a first processor programmed to process said image data, said first processor configured to perform either a high-speed processing program or a low-speed processing program;
a second processor programmed to process said image data, said second processor configured to perform either the high-speed processing program or the low-speed processing program; and
a controller configured to process said image data using a selective one or both of said first processor and said second processor, and controlling said selected one or both of said first processor and said second processor to each operate in the high-speed processing program or the low-speed processing program based on a remaining capacity in the output buffer.

13. The image processing apparatus of claim 12, wherein said controller is configured to process said image data using only the first processor operating in the low-speed operating program when a remaining capacity of the output buffer is less than a first predetermined remaining capacity value.

14. The image processing apparatus of claim 13, wherein said controller is configured to process said image data using said first processor in the high-speed operating program and said second processor in the high-speed operating program when a remaining capacity of the output buffer is greater than a second predetermined remaining capacity value, said second predetermined remaining capacity value being greater than said first predetermined remaining capacity value.

15. A method of processing image data, comprising:
receiving image data to be processed;
selecting one of a first processing speed and a second processing speed based on a remaining capacity of a buffer, wherein said second processing speed is greater than said first processing speed;
processing said image data at said selected processing speed; and
sending said processed image data to said buffer,
wherein said processing is done at said first processing speed when said remaining capacity is less than a predetermined remaining capacity value.

16. The method according to claim 15, wherein said second speed is selected when the buffer is about empty.

17. The method according to claim 15, wherein processing said image data at said selected processing speed processes said image data with a high-speed processing program when said second speed is selected and a low-speed processing program when said first speed is selected.

18. The method according to claim 15, wherein processing said image data at said selected processing speed processes said image data using a greater number of processors when said second speed is selected than when said first speed is selected.

19. The method according to claim 18, wherein processing said image data at said selected processing speed processes said image data with two processors when the second speed is selected and a single processor when said first speed is selected.

20. The method according to claim 15, wherein processing said image data at said selected processing speed processes said image data using a first processor and a second processor, each of said first and second processors configured to operate using a high-speed processing program or a low-speed processing program.
